(19) United States
(12) Patent Application Publication
(10) Pub. No.: US 2020/0409242 A1
(43) Pub. Date: Dec. 31, 2020

(54) GARMENT WITH INTEGRATED CAMERA WITH STABILIZER SYSTEM

(71) Applicants: Michael Isakov, Brooklyn, NY (US); Robert Lihalakha, Houston, TX (US)

(72) Inventors: Michael Isakov, Brooklyn, NY (US); Robert Lihalakha, Houston, TX (US)

(21) Appl. No.: 16/914,967

(22) Filed: Jun. 29, 2020

Related U.S. Application Data
(60) Provisional application No. 62/867,578, filed on Jun. 27, 2019.

(51) Int. Cl. G03B 17/56; F16M 11/20; F16M 13/04

(52) U.S. Cl. CPC G03B 17/561; F16M 13/04; F16M 11/2021

(57) ABSTRACT

The present invention is a headband comprising: an band of material, wherein the material is comprised of a series of interwoven strands and at least one of the strands has conductive properties; a controller integrated into the band of material and connected to the at least one of the conductive strands; and a camera integrated into the band of material and connected to at least one of the conductive strands which is also connected to the controller.

### CROSS-REFERENCE TO RELATED APPLICATIONS

This application is a continuation-in-part (and claims the benefit of priority under 35 USC 120) of U.S. application No. 62/867,578 filed Jun. 27, 2019. The disclosure of the prior applications is considered part of (and is incorporated by reference in) the disclosure of this application.

### BACKGROUND OF THE INVENTION

The present invention relates generally to a headband camera hardware system and method for fabricating stretchable, waterproof, lightweight, and connected fully embedded electronic assemblies within a garment in a manner that is stable for delivering video and audio recordings under dynamic motion in a variety of formats including virtual reality compatible video.

Sports are dynamic, widely adopted, and globally watched activities. Clear video and audio recordings of in game activity is highly desired by players, coaches, and fans for a multitude of reasons ranging from entertainment to performance analysis.

Current methods for tracking video data throughout a sporting event are generally in the third person with cameras pointed to the play area. Hardware systems and methods that seek to recreate a first-person view of an active player are bulky and unnatural, therefore they are never used in competitive games.

Sports garments are natural and popular amongst athletes of all ages and skill ranges. The headband is such one widely used sports garment category and is applicable to a set of highly popular sports including basketball and tennis.

Due to the bulky nature of electronic components and constant length wiring systems with low elasticity, embedding electronics within a sports garment such as the headband without compromising the headband's natural elastic behavior and light weight is extremely difficult.

Overcoming this difficulty would be greatly beneficial to all members of the sporting world. By maintaining the natural elastic, light weight, and stylish properties of the headband whilst adding several highly technical functions in recording high quality video and wirelessly transmitting that video to a computational device—the proposed solution would provide a natural point of view recording method for athletes, coaches, and fans thereby opening a whole new field of content for performance analysis and entertainment consumption.

The present invention seeks to provide a solution to this problem(s) by providing a system and methods for embedding electronics within a sports garment for the purpose of recording and transmitting video. The method focuses on embedding electronic components within a headband garment and maintaining conductivity of those electronics whilst also maintaining the elasticity of the garment, style of the garment, and weight of the garment.

### SUMMARY

Accordingly, it is an objective of the present invention is a headband comprising: an elastic band, wherein the elastic band is made from a series of woven strands of material; a camera integrated into the elastic band; an electrical system integrated into the band, wherein the electrical system comprises: a micro controller, a plurality of electrical connectors, and a plurality of electrical activation components; and an electrical wiring connecting the camera and the electrical system.

Accordingly, the present invention, may be comprised of a headband comprising: an band of material, wherein the material is comprised of a series of interwoven strands and at least one of the strands has conductive properties; a controller integrated into the band of material and connected to the at least one of the conductive strands; and a camera integrated into the band of material and connected to at least one of the conductive strands which is also connected to the controller.

The present invention may further comprise method of manufacturing a garment comprising: weaving a series of strands of material to form a band, wherein at least one of the strands as a conductive property; securing, within the formed band a series of electrical components, wherein the electrical components are electrically connected through the at least one strands of material with conductive properties.

### BRIEF DESCRIPTION OF THE DRAWINGS

FIG. 1 depicts an isometric view of a front view of the head band, in accordance with one embodiment of the present invention.

FIG. 2 depicts an isometric view of the front view of the head band, in accordance with one embodiment of the present invention.

FIG. 3 depicts an isometric view of the head band, in accordance with one embodiment of the present invention.

FIG. 4 depicts a block diagram of the electronics of the head band, in accordance with one embodiment of the present invention.

FIG. 5 depicts a block diagram of the network environment of the head band, in accordance with one embodiment of the present invention.

FIG. 6 depicts an isometric view of the front view of the head band, in accordance with another embodiment of the present invention.

FIG. 7 depicts an image of the fabric of the band, in accordance with one embodiment of the present invention.

### DETAILED DESCRIPTION OF THE INVENTION

The present invention provides for a head band with an integrated computer system and camera to provide first person recording for athletes and sporting events where the athletes of person needs to have their hands free, while also providing sweat and perspiration displacement from the wearer's eyes and face. This is advantageous over the current cameras and camera like systems which people are using to record their activities. The head band does not require mounting equipment or the like and which is present in the prior art. The head band is light, non-obtrusive, wirelessly connected, and provides for video stabilization with an integrated stabilization system connected to the camera. This headband can be used for sports (e.g. soccer, running, football, basketball, etc.), training (e.g. sports, military, etc.), and the like.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

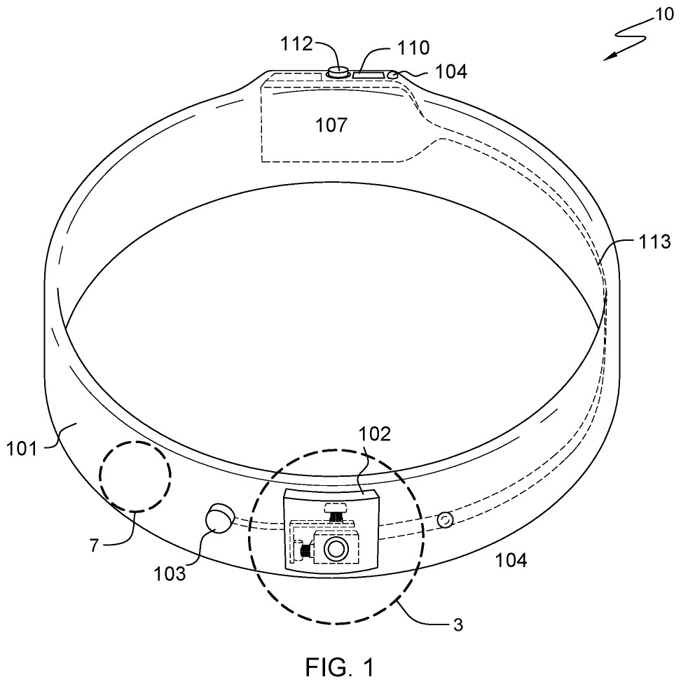

FIG. 1 depicts an isometric view of a front head band 100, in accordance with one embodiment of the present invention. The head band 100 is comprised of the band 101 with a series of electrical components integrated into the band 101. The band 101 is made from an absorbent and stretchable material such as polyester or spandex. Various styles of the band 101 are possible, such as a common headband known to one skilled in the art. The band 101 may be a flat piece of material or may be a closed loop design wherein an internal compartment is formed. The present invention is not limited to any style of band. In some embodiments, the band 101 is waterproof and equipped with electromagnetic wave radiation proofing or shielding. In the depicted embodiment, the band 101 is shown as a headband, however this technology could be implemented into various articles of clothing and garments.

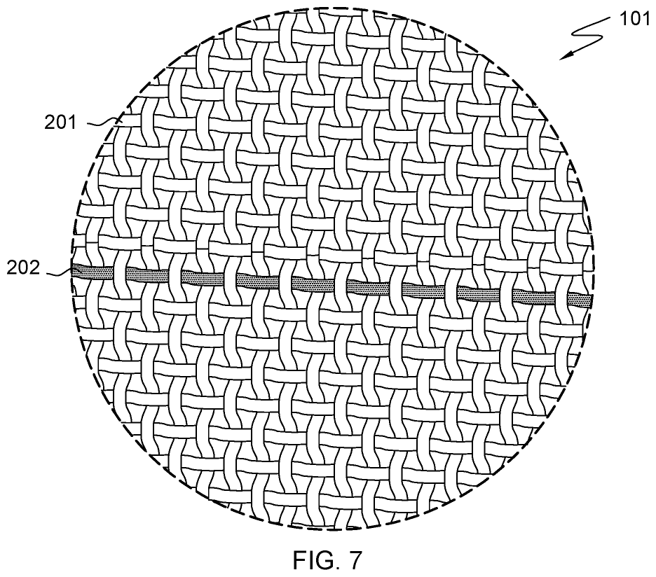

A system for capturing images and vide including one or more cameras, controllers, wireless drives, and a battery pack is integrated into the band 101. Integrated within the band 101 can be completed in several different methods. In a first embodiment, the system is integrated into the internal compartment of the band 101. In other embodiments, the system is integrated into the band 101 by being attached to the band 101. In these embodiments, there may be an additional layer of material applied over the band 101 to hid or conceal the components of the system. In additional embodiments, the system is interwoven with the band 101 material. This is accomplished by the material of the band 101 has the ability to transfer the electrical current required to connect the components of the system. As shown in FIG. 7, the band 101 is made from a material 201, wherein in the depicted embodiment, the material 201 is a series of strands which are interwoven. This material is maybe, but not limited to polyester, spandex, cotton, and other knitted or woven fabrics which have the desired elasticity and moisture removal properties. In the depicted embodiment, one of the strands 202 of the strands 201 has conductive property and can transfer and electrical signal from one component to the next, similar to a wire or cable. This conductive strand 202 is able to replace the wires and connect the electrical components of the headband 100. The strand 202 may be, but is not limited to silver infused thermoplastic polyurethane (e.g. rubber, plastic, silver) or the like, which is able to maintain the elasticity of the band 101 and have conductive properties to both power the components and transfer the data from the components.

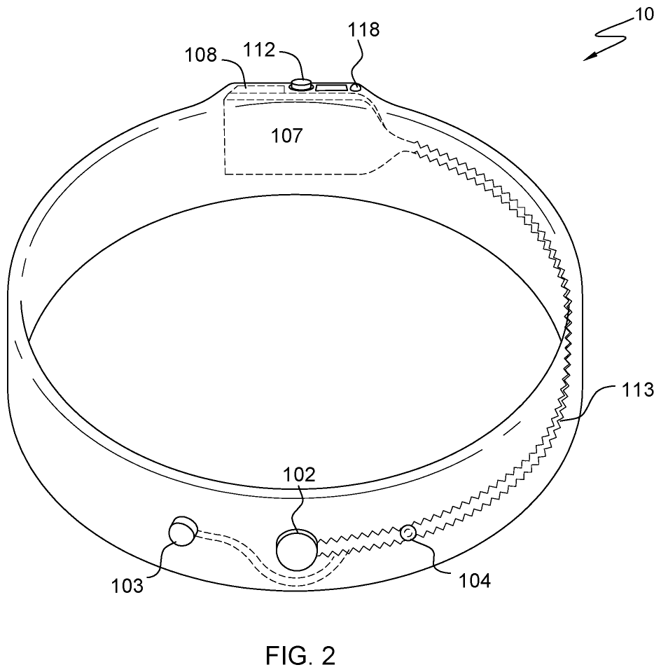

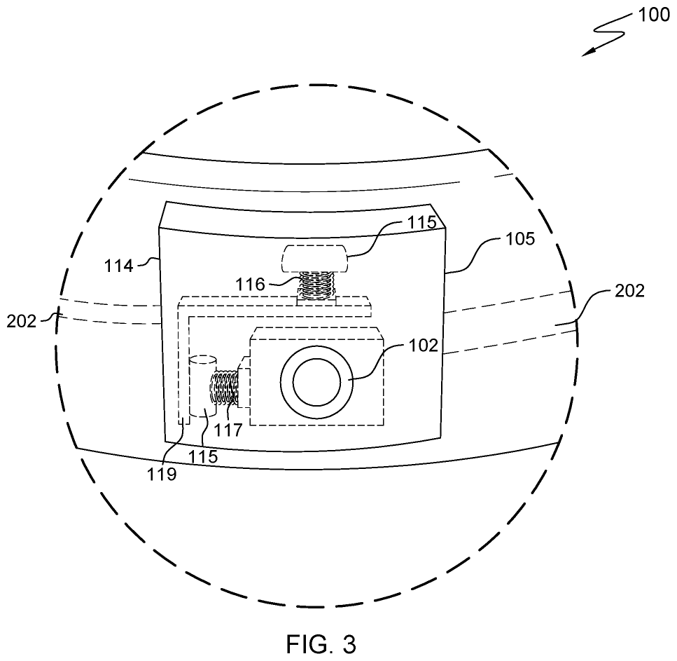

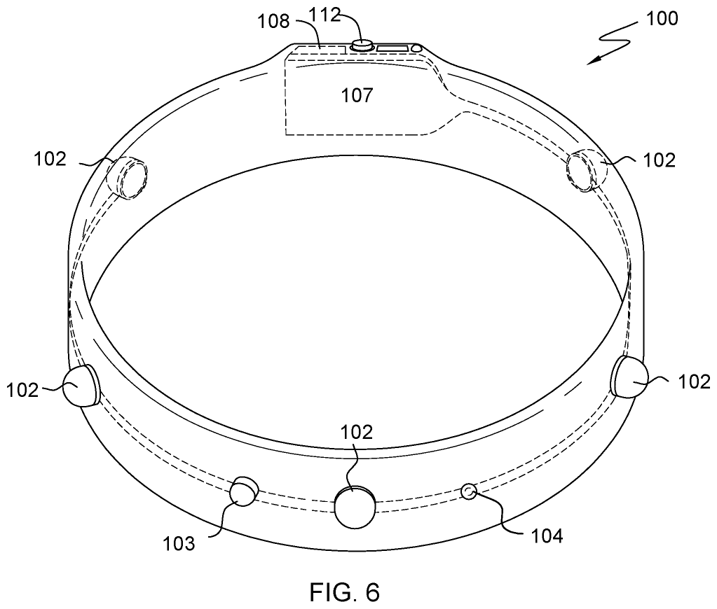

The components provide for the capturing of images, video, and audio and transfer the captured material to a remote location, providing power to the system. In the depicted embodiment, a camera 102 is integrated into a “front” of the band 101. The camera 102 provides for the ability to capture still images and videos. In the depicted embodiment, the camera 102 has a series of stabilizing components. These may be mechanical and electrical stabilizers. The onboard electronics are substantially embedded within the band 101 and they remain stable under asynchronous dynamic loads. In another embodiment, shown in FIGS. 2 and 6 the camera 102 has optical stabilization systems, digital stabilization systems, sensor-shift, or the like. In other embodiments, shown in FIGS. 1 and 3, the camera 102 has a mount 118 which connects to the band 101. The mount provides for the securement of the various dampers 116, motors 115, springs 117, mounting arm 119, and other mechanical components to counteract the movement of the wearer.

Integrated near the camera 102 is a microphone 103 to capture audio. A sensor 104 is integrated into the band 101 to assist in detecting light, darkness, and other properties to adjust the camera 102. In the depicted embodiment, the camera 102 is mounted onto an integrated plate 105. The plate provides for the mounting points for the mechanical stabilization components. In other embodiments, various indicator lights 120 are embedded into the band 101 to show when the camera is on, recording, and the like.

The electrical components are connected through wiring 113 integrated into the band 101. The system employs several novel techniques for manufacturing and connecting electronics within a band 101. In all cases these methods involve assembling electronics and wiring in a way that maintains the natural elasticity, lightweight properties, and adding in waterproof capability to the band 101. The primary method involves assembling the electronics in a compact form at the “back” of the headband 100, assembling the wiring 113 that links the camera 102, and microphone 103 to the electronics, and signaling interface onto a flexible non-conductive substrate and micro-folding that substrate along a guided path such that the connected electronics extend and contract synchronously with the band 101 as it is put under elastic loads. This effect is amplified by an interweaving of the band 101 with the wiring 113 as it wraps around the headband 100. In some embodiments, the substrates are of a length to reach from one component to the next. In other embodiments, the wiring 113 and the elastic substrate is folded (in an accordion style folding) when placed within the band 101 so that there is additional length in which the wiring 113 can stretch, as shown in FIG. 2.

Shown is the electrical components related to the controller 107, the battery 108, the charging port 110, indicator lights 118, and the controls 112. The charging port 110, indicator lights 118, and controls 112 are accessed from outside the band 101. The charging port 110 may have a cover or waterproof design. The controller 107 provides for the management, processing of the camera 102, microphone 103, sensors 104, and other mechanical and electrical components. In some embodiments additional connection ports are integrated into the system.

The manufacturing process of the headband 100 provides for the wiring 113 to have an elastic like properties. When the headband 100 is becoming completed, the electrical components are installed directly to the band 101. The wiring 113 is then applied to the band 101 to electrically connect the electrical components and complete the system. The primary wiring method involves printing a conductive solution onto a flexible garment compatible substrate which provides for the flexibility to expand and contrast with the band 101 without damaging the wiring 113 or the electrical components. In a second embodiment, the wiring method employs a unique folding mechanism applied to flexible substrate containing the conductive material. In all cases the substrate and wiring 113 are interwoven within the band 101, maintaining the elasticity, weight, and appearance of the functionally enhanced garment accessory. In some embodiments, another lay of the material is applied over the wiring 113 to protect the wiring 113 and still permit access to the other electrical components.

The controller 107 have a wireless module to communicate remotely to a computing device through custom applications, software, or programming a user can control or access the camera 102, microphone 103, sensors 104, and the controller 107 via a computing device (e.g. smartphone, mobile phone, computer, etc.). The controller 107 records, saves, and transmits videos and sensor data based on user commands and available connectivity reducing the requirement to have extension onboard storage. Connectivity is configurable via connected computing devices using custom applications. In some embodiments, the user is able to relay commands to the controller 107 via the microphone 103 and verbal commands.

The headband 100 is able to achieve the elasticity by separating the components into modules. This method enables flexibility of electronics such that control boards may mesh with the material fabrics used or fit to the contours of the wearer. Camera 102, controller 107, battery 108, and wiring 113 are also interwoven or meshed into the headband 100 with adhesive patterns such that any dynamic loads during wear are dampened. This aspect of the system ensures that the video image data is stable. The elasticity of the band 100 varies by embodiment in the magnitude of modularity and/or separation of components throughout the headband.

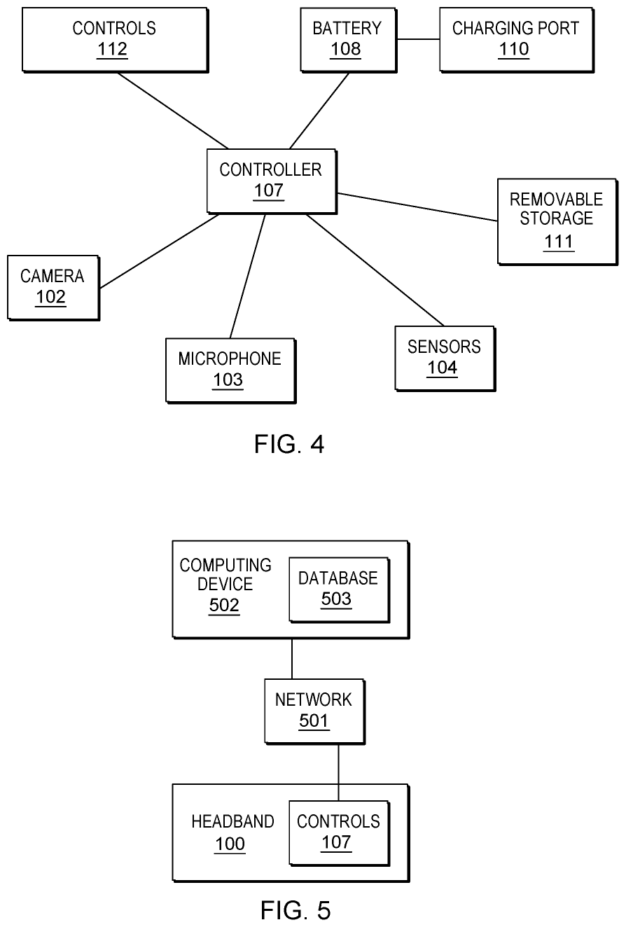

FIG. 4 depicts a block diagram of the electronics of the head band, in accordance with one embodiment of the present invention. The electronic system of the headband 100 includes a controller 107, camera 102, microphone 103, sensors 104, removable storage 111, battery 108, controls 112, and a charging port 110.

The charging port 110 that enables the system to both charge its power source and simultaneously apply a load to the onboard electronics. The charging port 110 is connected to the battery 108. The battery 108 is a rechargeable battery known to those skilled in the art. In some embodiments, the headband 100 has a removable storage 110 which may provide for an onboard storage of recorded data.

In an embodiment a series of buttons or controls 112 are integrated into the system to provide the means to control the device manually.

The primary assembly is wirelessly capable of transmitting data to an external web server through a wireless internet connection or similarly directly to a local connected device through a wireless connection means (e.g. Bluetooth or local area network connection). In either case an application running on a personal computing device may issue commands and receive data from the headband sports camera.

FIG. 5 depicts a block diagram of the network environment of the head band, in accordance with one embodiment of the present invention.

Network 502 may be a local area network (LAN), a wide area network (WAN) such as the Internet, any combination thereof, or any combination of connections and protocols that can support communications between computing device 502 and controller 107 in accordance with embodiments of the invention. Network 502 may include wireless connections.

Computing device 502 may be a management server, a web server, or any other electronic device or computing system capable of processing program instructions and receiving and sending data. In some embodiments, computing device 502 may be a laptop computer, tablet computer, netbook computer, personal computer (PC), a desktop computer, a mobile phone, a smart phone, or any programmable electronic device capable of communicating with controller 107 via network 501. In other embodiments, computing device 502 may represent a server computing system utilizing multiple computers as a server system, such as in a cloud computing environment. In another embodiment, computing device 502 represents a computing system utilizing clustered computers and components to act as a single pool of seamless resources. In the depicted embodiment, computing device 502 includes database 503. In other embodiments, computing device 502 may include various programs, functions, and the controller 107.

Controller 107 operates to control the camera, microphone, sensors, and the other electrical and mechanical components of the system to capture clear and stable images or videos. In the depicted embodiment, controller 107 is embedded in the band 101 utilizes network 501 to access the computing device 502. In one embodiment, controller 107 resides on computing device 502.

Database 503 may be a repository that may be written to and/or read by controller 107 In one embodiment, database 503 is a database management system (DBMS) used to allow the definition, creation, querying, update, and administration of a database(s). In the depicted embodiment, database 503 resides on computing device 502.

FIG. 6 depicts an isometric view of the head band, in accordance with another embodiment of the present invention. In another embodiment, multiple cameras 102 may be present inside a single band 101 using one of the aforementioned techniques or combination of techniques involving using modular linked electronic components or components which are assembled on a stretchable substrate. A method is then employed wherein the images from the cameras are stitched together to form 180 degree or 360-degree dynamic video and images. The processing may be split between or solely handled on the controller 107 or transferred to the computing device 502.

In these embodiments, the headband camera maintains its unique property of fully embedded, stretchable, and connected electronics within a traditional article of clothing that is lightweight, waterproof, and wear resistant.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed:

1. A headband comprising:
an elastic band, wherein the elastic band is made from a series of woven strands of material;
a camera integrated into the elastic band;
an electrical system integrated into the band, wherein the electrical system comprises:
a micro controller,
a plurality of electrical connectors, and
a plurality of electrical activation components; and
an electrical wiring connecting the camera and the electrical system.

2. The headband of claim 1, wherein a series of cameras are integrated into the elastic band to provide a complete 360 degrees of viewing

3. The headband of claim 1, wherein the wiring is applied to an elastic substrate.

4. The headband of claim 1, further comprising a mounting system for the camera, wherein the mounting system is integrated into the elastic band.

5. The headband of claim 1, wherein the elastic band is a single piece of material and is formed to create an interior compartment to conceal the camera and the electrical system.

6. The headband of claim 4, further comprising a series of sensors, wherein the sensors communicate with the mounting system to counteract the movement of the wearer.

7. The headband of claim 1, wherein the camera and the electrical system are positioned between the elastic band and a second elastic band

8. The headband of claim 1, wherein the wiring is folded in an accordion style.

9. A headband comprising:
a band of material, wherein the material is comprised of a series of interwoven strands and at least one of the strands has conductive properties;
a controller integrated into the band of material and connected to the at least one of the conductive strands; and
a camera integrated into the band of material and connected to at least one of the conductive strands which is also connected to the controller.

10. The headband of claim 9, further comprising a plurality of sensors electrically connected to the controller and the camera.

11. The headband of claim 9, wherein the camera has stabilizing properties

12. The headband of claim 9, wherein the controller is wirelessly connected to a network.

13. The headband of claim 11, further comprising a microphone connected to at least one of the plurality of sensors and the controller.

14. The headband of claim 9, wherein a plurality of cameras is integrated into the band of material and are positioned relative to one another.

15. The headband of claim 9, at least one indicator light is connected to the controller, wherein the indicator light is visible through the band of material.

16. A method of manufacturing a garment comprising:
weaving a series of strands of material to form a band, wherein at least one of the strands as a conductive property;
securing, within the formed band a series of electrical components, wherein the electrical components are electrically connected through the at least one strands of material with conductive properties.

17. The method of claim 16, wherein a camera is secured to a forward-facing direction of the band.

18. The method of claim 16, wherein the band forms a closed loop with an interior compartment.

19. The method of claim 18, wherein the electrical components are secured within the interior compartment.

20. The method of claim 19, wherein the camera is accessible through the interior compartment.
